(19) United States
(12) Patent Application Publication
(10) Pub. No.: US 2026/0231202 A1
(43) Pub. Date: Aug. 6, 2026

(54) INDICATION OF REQUIREMENTS OF A USER EQUIPMENT

(71) Applicant: NOKIA TECHNOLOGIES OY, Espoo (FI)

(72) Inventors: Toni Harri Henrikki LÄHTEENSUO, Helsinki (FI); Karri Markus RANTA-AHO, Espoo (FI); Sami-Jukka HAKOLA, Kempele (FI); Esa Tapani TIIROLA, Oulu (FI)

(21) Appl. No.: 19/149,429

(22) PCT Filed: Jan. 4, 2024
(86) PCT No.: PCT/EP2024/050145

§ 371 Date: Jul. 18, 2025

(30) Foreign Application Priority Data
Feb. 3, 2023 (FI) 20235099

(51) Int. Cl. H04W 72/543; H04W 72/0453

(52) U.S. Cl. CPC H04W 72/543; H04W 72/0453

(57) ABSTRACT

There is provided an apparatus comprising: at least one processor; and at least one memory storing instructions that, when executed by the at least one processor, cause the apparatus at least to perform: detecting that a network node is configured to operate with a first channel bandwidth associated with a first set of requirements, wherein the first channel bandwidth is at least one of: other than 5 MHz multiplied by a non-zero positive integer; or narrower than a nominal carrier bandwidth; detecting signalling by the network node, wherein the signalling comprises an indication that apparatuses meeting the first set of requirements on at least one condition are allowed to operate in or access a network comprising the network node; and transmitting, to the network node, at least one signal indicating that the apparatus does not meet the first set of requirements without at least one condition.

### FIELD

Various example embodiments relate to indication of requirements of a user equipment.

### BACKGROUND

At least in Europe, Future Railway Mobile Communication System (FRMCS) is agreed to be based on 5G new radio (NR). It has been planned that the global system for mobile communications-railway (GSM-R) will be migrated to NR.

### SUMMARY

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

According to an aspect, there is provided a method, comprising: detecting, by a user equipment, that a network node is configured to operate with a first channel bandwidth associated with a first set of requirements, wherein the first channel bandwidth is at least one of: other than 5 MHz multiplied by a non-zero positive integer; or narrower than a nominal carrier bandwidth; detecting, by the user equipment, signalling by the network node, wherein the signalling comprises an indication that apparatuses meeting the first set of requirements on at least one condition are allowed to operate in or access a network comprising the network node; and transmitting, by the user equipment to the network node, at least one signal indicating that the apparatus does not meet the first set of requirements without at least one condition.

According to an embodiment, the at least one condition is at least one of: lower maximum output power of the apparatus than nominally defined by the first set of requirements; or different in-band emission level of the apparatus than nominally defined by the first set of requirements.

According to an embodiment, the apparatus meets a second set of requirements comprising at least one of: lower maximum output power of the apparatus than nominally defined by the first set of requirements; or different in-band emission level of the apparatus than nominally defined by the first set of requirements.

According to an embodiment, the different in-band emission level is defined based on wider channel bandwidth than the first channel bandwidth.

According to an embodiment, the first channel bandwidth is less than 5 MHz; or the first channel bandwidth is 3 MHz; or the first channel bandwidth is 3 MHz to 5 MHz.

According to an embodiment, a first part of a number of resource blocks of bandwidth available for uplink is associated with the first set of requirements; and a second part of the number of the resource blocks of bandwidth available for uplink is associated with a second set of requirements, wherein the second part of the number of the resource blocks corresponds to flexible duplex operation.

According to an embodiment, the method comprises: receiving a configuration to access the network, wherein the configuration is indicative of not requiring the apparatus to meet the first set of requirements without at least one condition; adjusting internal configuration of the apparatus to meet the first set of requirements on the at least one condition.

According to an embodiment, the configuration is indicative of a number of resource blocks allocated for the apparatus, and wherein the number of resource blocks is based on available spectrum; or the number of resource blocks is based on a nominal channel bandwidth supported by the apparatus.

According to an embodiment, the method comprises: providing filtering capability of the apparatus to the network node.

According to an embodiment, the method comprises: determining requirements associated with a wider bandwidth than the first channel bandwidth; receiving a configuration of a bandwidth region associated with more stringent requirements than those associated with the wider bandwidth; receiving resource allocation for uplink transmission, wherein allocated resources overlap with the bandwidth region; and applying the more stringent requirements associated with the bandwidth region for the uplink transmission.

According to an embodiment, the more stringent requirements comprise more stringent in-band emission and maximum power reduction assumptions than the requirements associated with the first bandwidth region.

According to an aspect, there is provided an apparatus comprising means for performing the method of the aspect above and any of the embodiments thereof. The apparatus may be a user equipment.

According to an embodiment, the means comprises at least one processor; and at least one memory storing instructions that, when executed by the at least one processor, cause the performance of the apparatus. The apparatus may be a user equipment.

According to an aspect, there is provided a (non-transitory) computer readable medium comprising instructions that when executed by an apparatus, cause the apparatus to perform the method of the aspect above and any of the embodiments thereof. The apparatus may be a user equipment.

According to an aspect, there is provided a computer program comprising instructions, which, when executed by an apparatus, cause the apparatus to perform the method of the aspect above and any of the embodiments thereof. The apparatus may be a user equipment.

According to an aspect, there is provided a method, comprising: determining, by a network node that user equipments meeting a first set of requirements on at least one condition are allowed to operate in or access a network comprising the apparatus configured to operate with a first channel bandwidth associated with the first set of requirements, wherein the first channel bandwidth is at least one of: other than 5 MHz multiplied by a non-zero positive integer; or narrower than a nominal carrier bandwidth; transmitting, by the network node, signalling comprising an indication that user equipments meeting the first set of requirements on at least one condition are allowed to operate in or access the network; receiving, by the network node from at least one user equipment, at least one signal indicating that the at least one user equipment does not meet the first set of requirements without at least one condition.

According to an embodiment, the at least one condition is at least one of: lower maximum output power of the at least one user equipment than nominally defined by the first set of requirements; or different in-band emission level of the user equipment than nominally defined by the first set of requirements.

According to an embodiment, the at least one user equipment meets a second set of requirements comprising at least one: lower maximum output power of the at least one user equipment than nominally defined by the first set of requirements; or different in-band emission level of the at least one user equipment than nominally defined by the first set of requirements.

According to an embodiment, the different in-band emission level is defined based on wider channel bandwidth than the first channel bandwidth.

According to an embodiment, the method comprises: transmitting, to the at least one user equipment, a configuration to access the network, wherein the configuration is indicative of not requiring to meet the first set of requirements without at least one condition.

According to an embodiment, the method comprises: receiving filtering capability of the user equipment.

According to an embodiment, the method comprises: transmitting, to the user equipment, a configuration of a bandwidth region associated with more stringent requirements than those associated with a wider bandwidth than the first channel bandwidth; transmitting, to the user equipment, resource allocation for uplink transmission, wherein allocated resources overlap with the bandwidth region.

According to an aspect, there is provided an apparatus comprising means for performing the method of the aspect above and any of the embodiments thereof. The apparatus may be a network node.

According to an embodiment, the means comprises at least one processor; and at least one memory storing instructions that, when executed by the at least one processor, cause the performance of the apparatus. The apparatus may be a network node.

According to an aspect, there is provided a (non-transitory) computer readable medium comprising instructions that when executed by an apparatus, cause the apparatus to perform the method of the aspect above and any of the embodiments thereof. The apparatus may be a network node.

According to an aspect, there is provided a computer program comprising instructions, which, when executed by an apparatus, cause the apparatus to perform the method of the aspect above and any of the embodiments thereof. The apparatus may be a network node.

### BRIEF DESCRIPTION OF THE DRAWINGS

Some example embodiments will now be described with reference to the accompanying drawings.

FIG. 1 shows, by way of example, interfering signal 100 located within a channel bandwidth;

FIG. 2a and FIG. 2b show, by way of examples, interference scenarios;

FIG. 3 shows, by way of example, a flowchart of a method;

FIG. 4 shows, by way of example, a flowchart of a method;

FIG. 5a shows, by way of example, effect of power reduction and effect of in-band emission level increase.

FIG. 5b shows, by way of example, a table of resource blocks;

FIG. 6 shows, by way of example, a flowchart of a method of an embodiment; and

FIG. 7 shows, by way of example, a block diagram of an apparatus.

### DETAILED DESCRIPTION

At least in Europe, Future Railway Mobile Communication System (FRMCS) is agreed to be based on 5G NR. It has been allocated 2×5.6 MHz frequency division duplex (FDD) spectrum (874.4-880 MHz/919.4-925 MHz). Part of the spectrum is currently used by global system for mobile communications—railway (GSM-R). It has been planned that GSM-R will be slowly migrated to NR during 2025-2035. This new system for mobile communication in railways may be referred to as NR-R or 5G-R.

Initially, approximately 3.6 MHz of spectrum will be available for NR, and GSM-R signals will be present immediately outside this 3.6 MHz. Currently, the narrowest specified NR channel bandwidth is 5 MHz, meaning that current UE radio frequency (RF) implementations are not optimized for narrower than 5 MHz allocations. For example, supported UE filter bandwidths do not go below 5 MHz.

3rd Generation Partnership Project, 3GPP, has approved a work item for release 18 (Rel-18) for dedicated spectrum less than 5 MHz, e.g. from 3 MHz to 5 MHz. However, the operating band n100 (rail mobile radio, RMR, band) matching to FRMCS spectrum was standardized already in Rel-17 and therefore supports only 5 MHz channel bandwidth currently. This creates a mismatch in channel bandwidth support and UE abilities between releases. In Rel-18 time frame, it is possible that both UEs implemented with 5 MHz capable RF chains, and UEs implemented with both below 5 MHz (e.g. 3 MHz) and 5 MHz capable RF chains exist, and these UEs will have different abilities when it comes to tolerating the GSM-R signals.

Transmit modulation quality for expected in-channel RF transmissions from the UE is specified by error vector magnitude (EVM) for allocated resource blocks (RBs), EVM equalizer spectrum flatness derived from the equalizer coefficients generated by the EVM measurement process, carrier leakage and in-band emissions (IBE) for the non-allocated RBs.

The in-band emission is defined as the average emission across 12 sub-carriers and as a function of the RB offset from the edge of the allocated uplink (UL) transmission bandwidth. The in-band emission is measured as the ratio of the UE output power in a non-allocated RB to the UE output power in an allocated RB.

Existing NR channel bandwidths are integer multiples of 5 MHz. 3GPP is studying how to efficiently utilize spectrum that is not aligned with the existing NR channel bandwidths. For example, these irregular channel bandwidths may be: 7, 11, 12 MHz (n5 band); 6, 12 MHz (n12, n85 bands); 7 MHz (n26 band); 13 MHz (n28 band); 6, 11 MHz (n29 band).

Flexible duplexing refers to dynamic assignment of transmission and reception resources within a channel bandwidth (CBW), wherein certain UEs may be configured to transmit UL on a portion of the (unpaired) CBW while another UE may be configured to receive downlink (DL) on another portion of the (unpaired) CBW. Based on that, gNB may transmit and receive at the same time on the CBW. The UL and DL portions may be non-overlapping in frequency, but overlapping in time. In full duplex mode, transmission and reception may occur simultaneously on the resources overlapping in frequency. Regardless of the duplexing mode at the gNB (half duplex, flexible duplex, full duplex), the UEs may always operate in half-duplex mode, wherein the UE may transmit or receive at a given time within a CBW, but not transmit and receive at the same time within a CBW.

Similar to the FRMCS and GSM-R coexistence, the UE supporting such flexible duplexing operation would benefit from tighter frequency isolation between the Tx interference and the Rx wanted signal bands to avoid interference from the other UEs'UL transmissions adjacent in frequency interfering with the wanted DL signal being received. The UEs may employ a tighter transmit frequency mask to reduce the interference they cause to the other UEs.

Some UEs may support the existing performance requirements not taking the flexible duplexing into account. Some UEs may support different levels of Rx filtering to reject the flexible duplexing UL-to-DL interference as well as different levels of Tx filtering to limit the interference they leak around the transmitted signal in frequency.

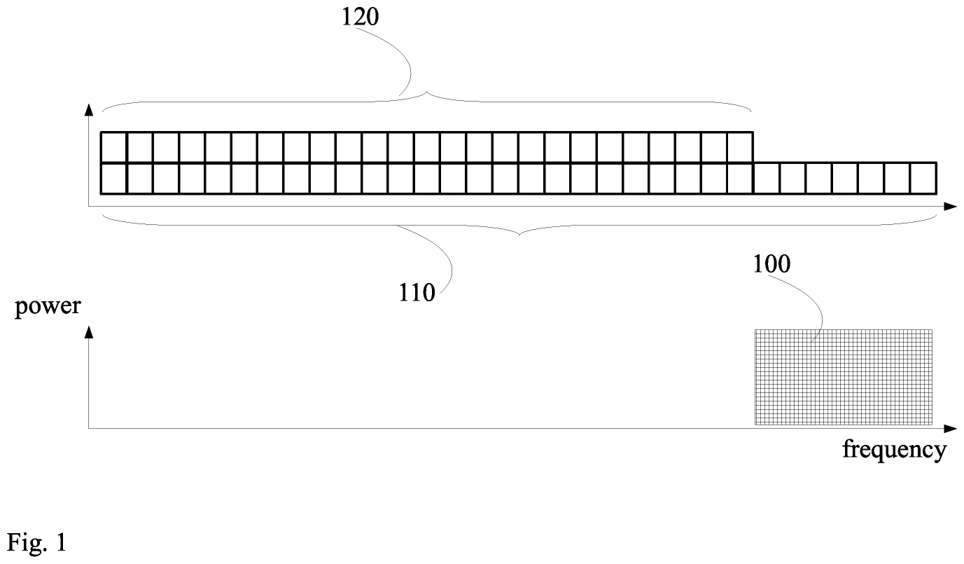

FIG. 1 shows, by way of example, interfering signal 100 located within a channel bandwidth (CBW) 110. Interference may occur, for example, when FRMCS coexists with GSM-R, or when UE experiences flexible duplexing UL-to-DL interference. In-band interference problem relates to large power imbalance, where a high power interfering signal 100, which may be non-overlapping in frequency with configured BWP 120 (wanted signal), is still within the nominal CBW 110 of the carrier, wherein the wanted signal 120 is received.

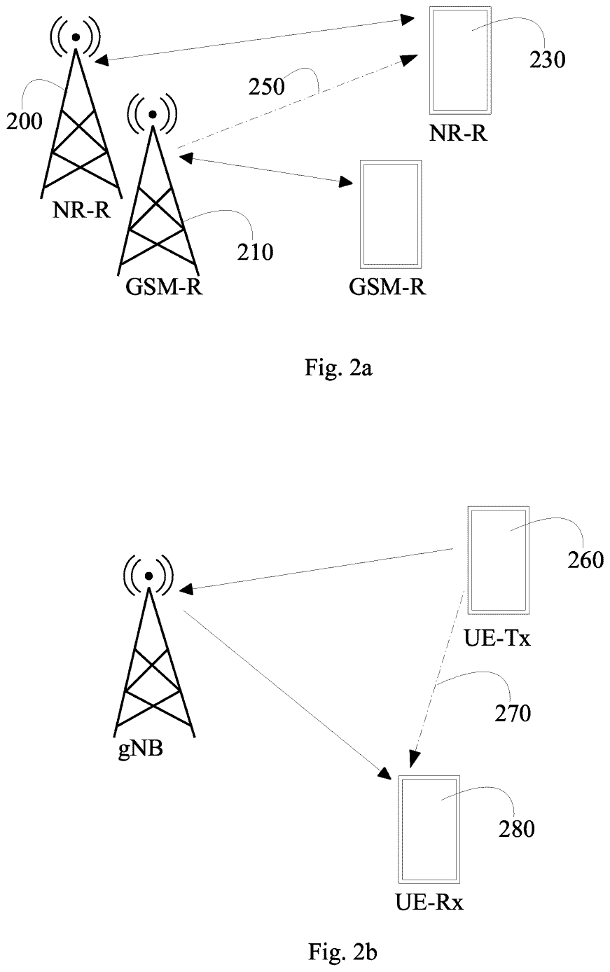

FIG. 2a and FIG. 2b show, by way of examples, interference scenarios. For example, when FRMCS or NR-R 200 coexists with GSM-R 210, NR-R UE 230 may experience interference 250 from the GSM-R signal. As another example, in flexible duplexing scenario of FIG. 2b, transmitting UE 260 may cause interference 270 to a receiving UE 280.

Methods are provided to enable UEs with varying RF capabilities, e.g. associated with 3 MHz or 5 MHz, to operate in narrow spectrum, e.g. in 3 MHz spectrum, without causing excessive interference; and to enable network node to control this. The network node may be configured to operate with irregular bandwidths, e.g. bandwidths other than 5 MHz multiplied by a non-zero positive integer; and/or with bandwidths narrower than a nominal carrier bandwidth. The nominal carrier bandwidth may correspond to one of the following bandwidth options, for example: 5 MHz, 10 MHz, 15 MHz, 20 MHz, 25 MHz, 30 Hz, 40 MHz, 50 MHz, 60 Hz, 70 Hz, 80 MHz, 90 MHz, or 100 MHz. Operation with bandwidth, which is narrower than the nominal carrier bandwidth, may correspond to operation according to requirements defined for a narrower CBW than the nominal bandwidth. For example, the network may apply 10 MHz requirements in 20 MHz CBW.

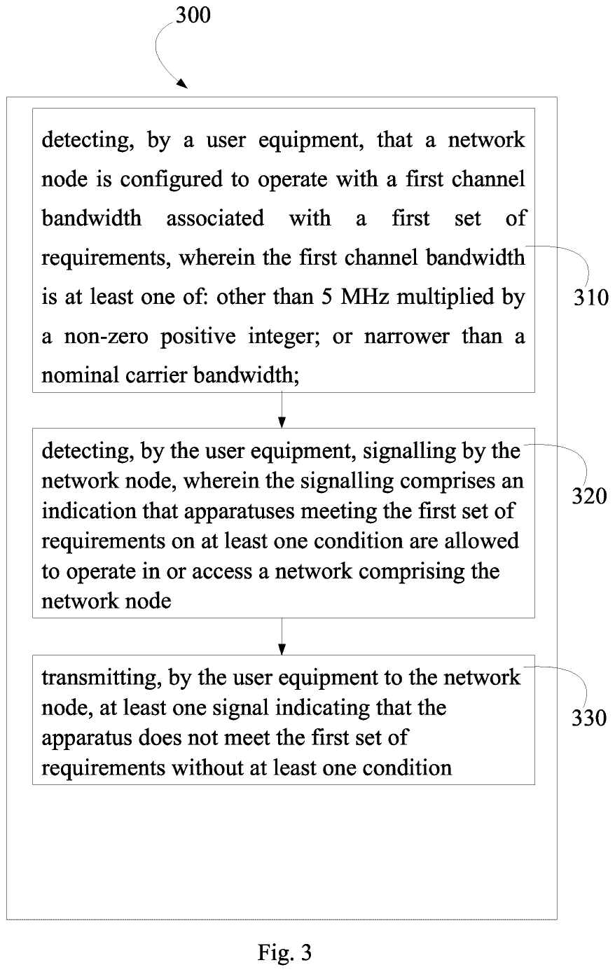

FIG. 3 shows, by way of example, a flowchart of a method 300. The phases of the illustrated method may be performed by a UE, or by a control device configured to control the functioning thereof, when installed therein. The UE may relate to FRMCS operation and may be a handheld UE or a train-mounted UE, for example. As another example, the UE may relate to flexible duplex scenario. The method 300 comprises detecting 310, by a user equipment, that a network node is configured to operate with a first channel bandwidth associated with a first set of requirements, wherein the first channel bandwidth is at least one of: other than 5 MHz multiplied by a non-zero positive integer; or narrower than a nominal carrier bandwidth. The method 300 comprises detecting 320, by the user equipment, signalling by the network node, wherein the signalling comprises an indication that apparatuses meeting the first set of requirements on at least one condition are allowed to operate in or access a network comprising the network node. The method 300 comprises transmitting 330, by the user equipment to the network node, at least one signal indicating that the apparatus does not meet the first set of requirements without at least one condition.

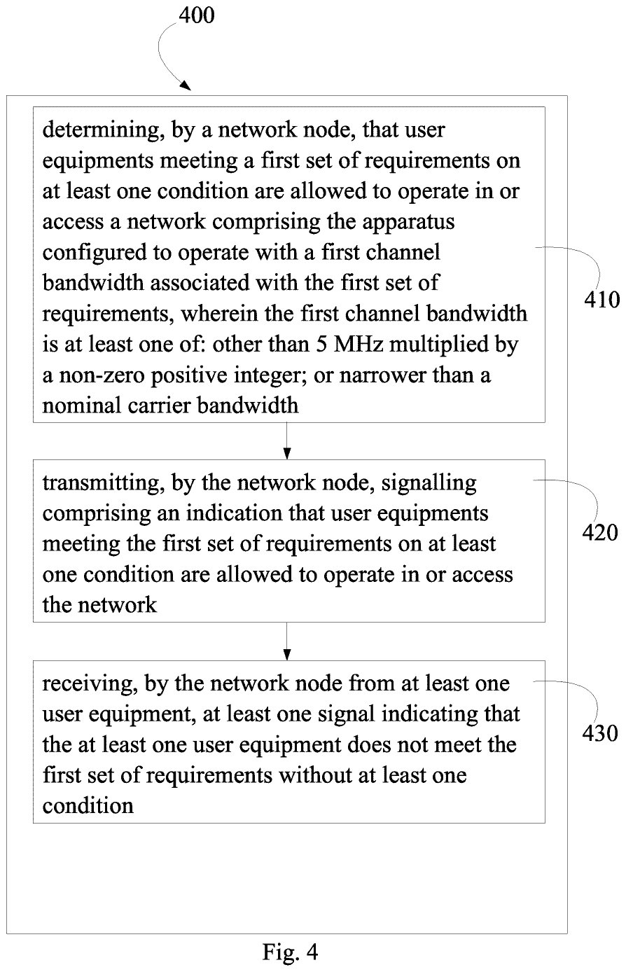

FIG. 4 shows, by way of example, a flowchart of a method 400. The phases of the illustrated method may be performed by a network node, e.g. gNB, or by a control device configured to control the functioning thereof, when installed therein. The network node may relate to FRMCS operation and may be a train-mounted network node, for example. The method 400 comprises determining 410, by a network node, that user equipments meeting a first set of requirements on at least one condition are allowed to operate in or access a network comprising the apparatus configured to operate with a first channel bandwidth associated with the first set of requirements, wherein the first channel bandwidth is at least one of: other than 5 MHz multiplied by a non-zero positive integer; or narrower than a nominal carrier bandwidth. The method 400 comprises transmitting 420, by the network node, signalling comprising an indication that user equipments meeting the first set of requirements on at least one condition are allowed to operate in or access the network. The method 400 comprises receiving 430, by the network node from at least one user equipment, at least one signal indicating that the at least one user equipment does not meet the first set of requirements without at least one condition.

The method(s) as disclosed herein enable(s) the network node to control over UEs which may access the network. This is beneficial in networks operating with irregular bandwidths. For example, FRMCS, smart grid and public safety communications are mission critical, and special user devices may be manufactured for these purposes. This kind of UE might not need to be mandated to support all channel bandwidths for the operating band, but on the other hand, to guarantee chipset availability, it is beneficial to support UEs only supporting regular RF bandwidths (integer multiples of 5 MHz).

The method(s) as disclosed herein enable(s) larger UE base or larger amount of UEs with different capabilities to be used for irregular channel bandwidths, e.g. for less than 5 MHz, in network controlled manner. For example, mission critical networks may be restricted for UEs optimized for those, e.g. UEs supporting some exact channel bandwidth, e.g. 3 MHz.

The UE may detect that the network node is configured to operate with a first channel bandwidth associated with a first set of requirements. The first channel bandwidth is irregular channel bandwidth, or in other words, other than 5 MHz bandwidth multiplied by a positive non-zero integer; and/or narrower than a nominal carrier bandwidth.

The UE may detect the use of the first channel bandwidth via system information, e.g. system information block 1 (SIB1), or the UE may determine the use of the first channel bandwidth by detecting the specific synch raster point primary synchronization signal or secondary synchronization signal (PSS/SSS). The first channel bandwidth may be, for example, 3 MHz, or 3 MHz to 5 MHz, or less than 5 MHz.

The UE may detect network signalling (NS) comprising an indication that UEs meeting the first set of requirements on at least one condition are allowed to operate in or access the network. Then, the UE may transmit to the network node at least one signal indicating that it does not meet the first set of requirements without at least one condition. The at least one signal may be a capability report.

The network signalling may be broadcast signalling, and the indication of allowing UEs with relaxed requirements may be included in an NS-value. By not broadcasting this NS-value, the network node may bar access to UEs, which have sub-optimal performance due to not meeting the first set of requirements without any conditions.

The at least one condition may be, for example, that the maximum applied output power of the UE is lower than nominally defined by the first set of requirements. For example, the UE may be able to transmit with nominally defined Tx power, but it may still fail to meet the emission requirements. If the UE is desired to meet the requirements, the lower Tx power is to be allowed for the UE. For example, UE may be allowed for larger maximum power reduction (which corresponds to reducing the maximum Tx power requirement) by configuration, and/or the power restriction may be taken into account in the power control.

As another example, the at least one condition may be that the in-band emission (IBE) level of the UE may be different than nominally defined by the first set of requirements. For example, the IBE level may be defined based on a wider channel bandwidth than the first channel bandwidth. For example, the IBE level may be defined based on 5 MHz CBW instead of 3 MHz CBW, which may be the operation bandwidth of the network node. For example, the UE may be allowed to transmit with the nominally defined power, but the IBE level may be worse than nominally defined.

The network may pick one of the conditions, for example. That is, the network may choose that either the maximum Tx power requirement of the UE is lowered or IBE level of the UE is worse than nominally defined.

The network may choose to reduce the Tx power requirement to some extent, but not enough to get the IBE under the required level. In this case, the both conditions would apply, as the Tx power requirement is reduced, e.g. a little bit reduced, and the IBE level requirement is increased, e.g. a little bit increased.

When the network determines, which condition to choose, it may prioritize power (achievable data rate or coverage) and/or prioritize emissions.

For example, if the network has more spectrum available than the wanted signal occupies, the network may choose to prioritize power, and reduce the Tx power requirement. With higher Tx power, the interference may leak to the adjacent PRBs and interfere with them, which may lead to situation that the PRBs should be left unused or the other UE scheduled to those PRBs would need to be scheduled with more robust modulation and coding scheme (MCS) with lower data rate.

As another example, if the Tx power is acceptable (lower data rate and no concern on coverage), the network may choose to prioritize emissions.

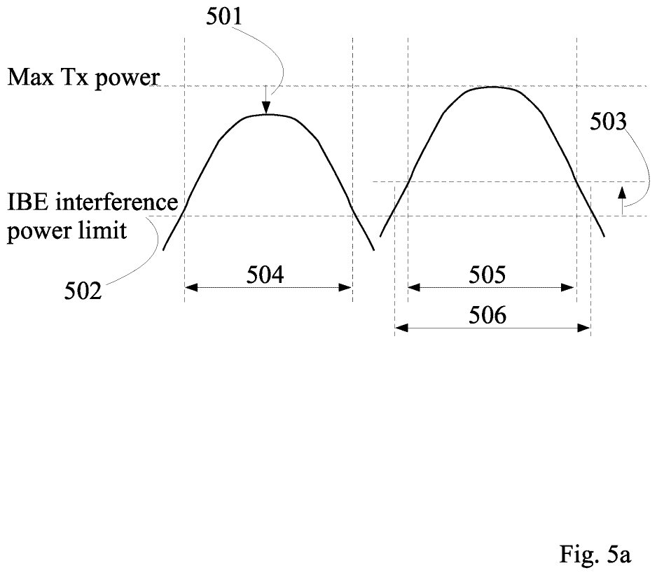

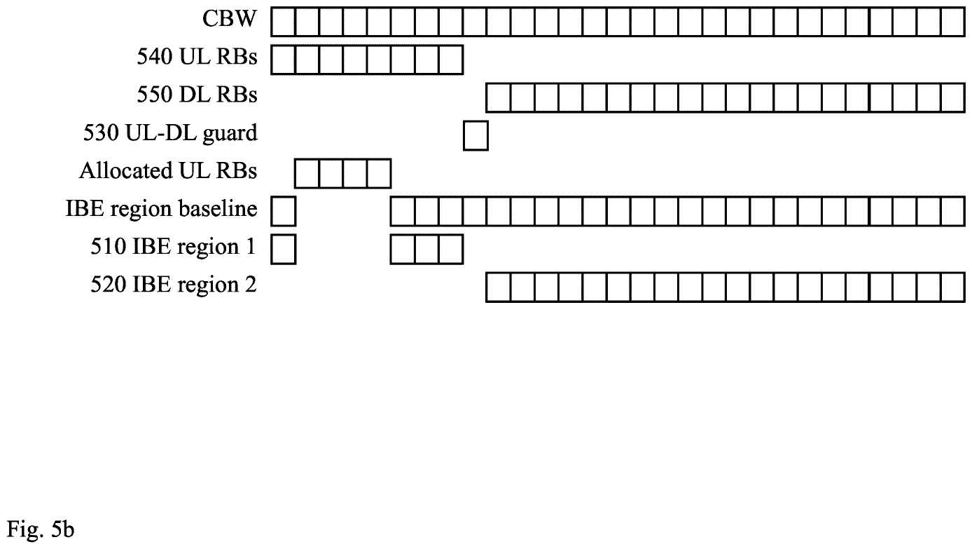

FIG. 5a shows, by way of example, effect of power reduction and effect of IBE level increase. On the left side, it is shown how reducing 501 the maximum Tx power allows the transmission to stay within the allocated BW 504 (in the emission mask) without the interference level outside the allocated BW exceeding the interference power limit 502.

On the right side, it is shown how allowing the IBE interference power limit to increase 503, the transmission does not stay within the allocated BW 505, but the interference leaks to the adjacent PRBs. Thus, the actually consumed BW 506 is wider than the allocated BW 505. The UE is allowed to transmit with higher Tx power, e.g. with max Tx power.

When the network is made aware of UE performing better than the worst possible allowed performance, the network node is enabled to optimize scheduling and higher data rates. For example, the UE supporting the legacy requirements (requirements associated with the wider BW than the first BW, or the worst possible allowed performance) may be assigned with a narrower bandwidth, leaving some part of the overall bandwidth unused as guard, leading to reduced performance compared to those UEs known to perform better than the worst possible allowed performance. As another example, the UE supporting the legacy requirements may be assigned with a lower modulation and/or coding scheme, with lower spectral efficiency transmission and reduced power, to reduce the UE's used transmission power, again leading to reduced performance.

The additional conditions may be available for predefined bands, e.g. only for predefined bands, e.g. for n100 band.

The UE may be configured to meet a second set of requirements comprising at least one of: lower output power of the UE than nominally defined by the first set of requirements; or different in-band emission level of the UE than nominally defined by the first set of requirements.

The UE may receive a configuration to access the network. The configuration is indicative of not requiring the UE to meet the first set of requirements without at least one condition. After receiving the configuration, the UE may adjust internal configuration to meet the first set of requirements on the at least one condition.

The configuration may be indicative of a number of resource blocks allocated for the UE. For example, the number of resources blocks (N_RB) may be based on available spectrum. In other words, the N_RB may be restricted to not be larger than the real amount of RBs that may be configured to the UE irrespective of what is the nominal CBW used by the UE.

As another example, the N_RB may be based on a nominal CBW supported by the UE, or the next wider legacy CBW. This way, the UE performance is comparable to using nominal channel bandwidth.

Choice between alternatives of the N_RB is based on network signalling, e.g. an NS value indicated by the network.

FIG. 5b shows, by way of example, a table of resource blocks. First or current IBE rules may apply for certain RBs of the carrier, for example, only for certain RBs of the carrier, such as IBE region 1 510 of FIG. 5. For example, the first IBE rules may relate only to UL RBs of the carrier configured to operate in flexible duplex scenario.

The rest of the RBs, such as IBE region 2 520 of FIG. 5b, may follow second IBE rules. There may be more IBE regions than shown in FIG. 5b.

There are multiple ways to define IBE rules or requirements for the IBE region 2 520. For example, a fixed offset may be determined with respect to the first IBE rules. For example, it may be determined that the IBE level of the second IBE rules is 5 dB stricter than the IBE level of the first IBE rules.

As another example, a fixed emission level may be determined, e.g. z dBm/MHz, or y dBm/RB.

As a further example, a combination of the fixed offset and the fixed emission level may be determined. For example, it may be determined that both requirements need to be followed.

IBE requirements or rules of the IBE region 2 may involve separate maximum power reduction (MPR) behavior than IBE region 1. For example, when transmission involves IBE region 2, the UE may be allowed to increase the MPR by x dB, that is, the UE may support adaptive MPR (A-MPR). The actual MPR for UE is then MPR (dB)+x dB. The requirement for the max Tx power reduces accordingly.

There may be multiple sets of requirements for the IBE region 2, wherein each IBE region 2 has predefined allowance for MPR increase. For example: ΔIBE=−5 dB, A-MPR=3 dB; or ΔIBE=−8 dB, A-MPR=5 dB. This requirement may relate to UE category.

There may be multiple UE categories behind the certain ΔIBE. For example, a high-end UE having good filtering capability may have the following requirements: ΔIBE=−8 dB, A-MPR=2 dB. As another example, a low-end UE having worse filtering capability may have the following requirements: ΔIBE=−8 dB, A-MPR=5 dB.

A guard band 530 may be configured between UL and DL portion. The amount of the guard band RBs may be a parameter configured via RRC. The guard band may be considered as resources where rules defined for IBE region 1 are followed. Alternatively, it may be considered as resources where IBE rules are not followed. Alternatively, it may be considered as resources where rules defined for IBE region 2 are followed. Alternatively, it may be considered as resources where some other predefined IBE rules are followed.

The guard band 530 may or might not overlap with UL RBs 540 and/or DL RBs 550. For example, UE may assume that its RB allocation does not overlap with the guard band.

The guard band size, e.g. the minimum guard band size, may be an UE capability. The capability may be reported to the network node.

The guard band size may impact on ΔIBE and/or A-MPR.

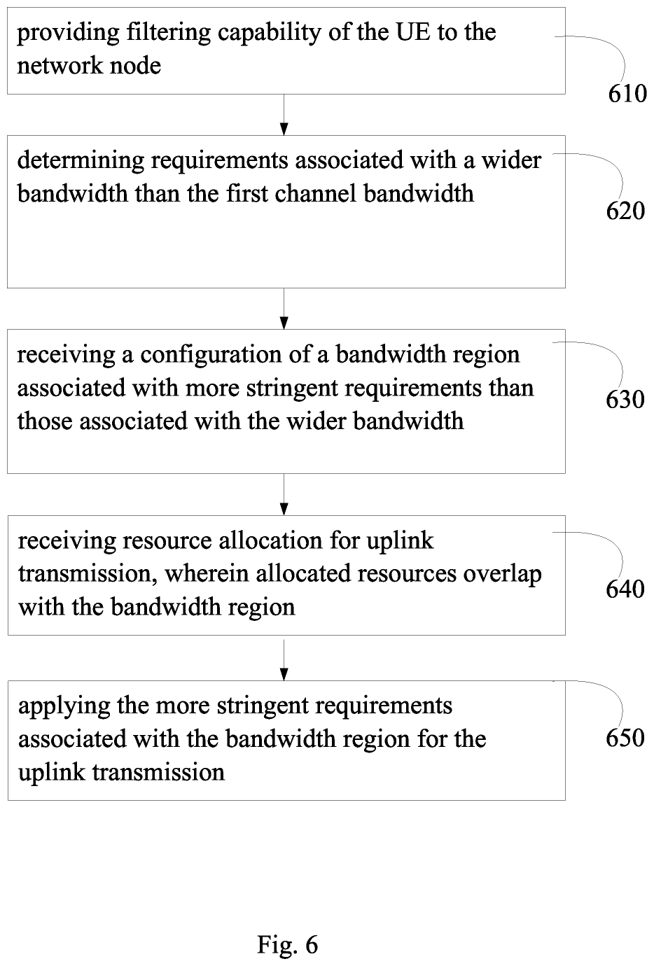

FIG. 6 shows, by way of example, a flowchart of a method of an embodiment with dynamic adjustment of IBE and/or MPR depending on UL resource allocation. The UE may provide 610 filtering capability of the UE to the network node. For example, the filtering capability may be given as high or low filtering capability.

The UE may determine 620 requirements associated with a wider bandwidth than the first channel bandwidth (legacy requirements).

The UE may receive 630 a configuration of a bandwidth region associated with requirements associated with more stringent requirements than those associated with the wider bandwidth.

The UE may have determined the assumptions, e.g. IBE and MPR assumptions, for the bandwidth region previously. For example, the UE may have received the assumptions from the network, or the UE may have determined ΔIBE and A-MPR according to the UE capability.

The UE may receive 640 resource allocation for the uplink transmission. The allocated resources may overlap with the bandwidth region.

The UE may apply 650 more stringent requirements associated with the bandwidth region for the uplink transmission.

The more stringent requirements may comprise more stringent IBE and MPR assumptions than the requirements associated with the wider bandwidth than the first channel bandwidth.

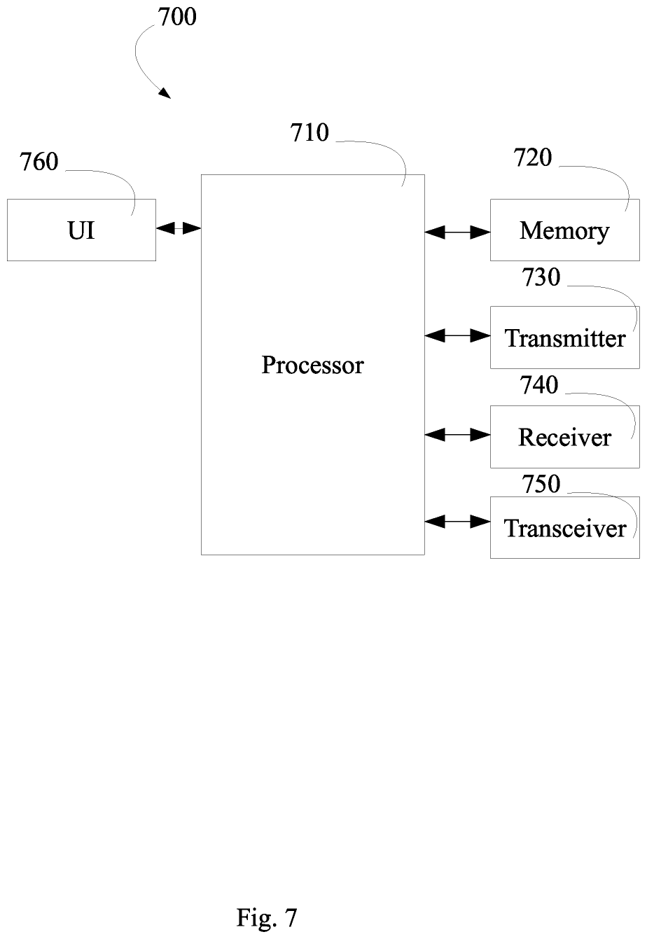

FIG. 7 shows, by way of example, a block diagram of an apparatus capable of performing the method(s) as disclosed herein. Illustrated is device 700, which may comprise, for example, a UE or network node of FIG. 2a or FIG. 2b. Comprised in device 700 is processor 710, which may comprise, for example, a single-or multi-core processor wherein a single-core processor comprises one processing core and a multi-core processor comprises more than one processing core. Processor 710 may comprise, in general, a control device. Processor 710 may comprise more than one processor. Processor 710 may be a control device. Processor 710 may comprise at least one application-specific integrated circuit, ASIC. Processor 710 may comprise at least one field-programmable gate array, FPGA. Processor 710 may be means for performing method steps in device 700. Processor 710 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment or a network node, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 700 may comprise memory 720. Memory 720 may comprise random-access memory and/or permanent memory. Memory 720 may comprise at least one RAM chip. Memory 720 may comprise solid-state, magnetic, optical and/or holographic memory, for example. Memory 720 may be at least in part accessible to processor 710. Memory 720 may be at least in part comprised in processor 710. Memory 720 may be means for storing information. Memory 720 may comprise instructions, such as computer instructions or computer program code, that processor 710 is configured to execute. When instructions configured to cause processor 710 to perform certain actions are stored in memory 720, and device 700 overall is configured to run under the direction of processor 710 using instructions from memory 720, processor 710 and/or its at least one processing core may be considered to be configured to perform said certain actions. Memory 720 may be at least in part external to device 700 but accessible to device 700.

Device 700 may comprise a transmitter 730. Device 700 may comprise a receiver 740. Transmitter 730 and receiver 740 may be configured to transmit and receive, respectively, information in accordance with at least one cellular or non-cellular standard. Transmitter 730 may comprise more than one transmitter. Receiver 740 may comprise more than one receiver. Transmitter 730 and/or receiver 740 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 700 may comprise a near-field communication, NFC, transceiver 750. NFC transceiver 750 may support at least one NFC technology, such as NFC, Bluetooth, Wibree or similar technologies.

Device 700 may comprise user interface, UI, 760. UI 760 may comprise at least one of a display, a keyboard, a touchscreen, a vibrator arranged to signal to a user by causing device 700 to vibrate, a speaker and a microphone. A user may be able to operate device 700 via UI 760, for example to accept incoming telephone calls, to originate telephone calls or video calls, to browse the Internet, to manage digital files stored in memory 720 or on a cloud accessible via transmitter 730 and receiver 740, or via NFC transceiver 750, and/or to play games.

Processor 710 may be furnished with a transmitter arranged to output information from processor 710, via electrical leads internal to device 700, to other devices comprised in device 700. Such a transmitter may comprise a serial bus transmitter arranged to, for example, output information via at least one electrical lead to memory 720 for storage therein. Alternatively to a serial bus, the transmitter may comprise a parallel bus transmitter. Likewise processor 710 may comprise a receiver arranged to receive information in processor 710, via electrical leads internal to device 700, from other devices comprised in device 700. Such a receiver may comprise a serial bus receiver arranged to, for example, receive information via at least one electrical lead from receiver 740 for processing in processor 710. Alternatively to a serial bus, the receiver may comprise a parallel bus receiver.

Processor 710, memory 720, transmitter 730, receiver 740, NFC transceiver 750, and/or UI 760 may be interconnected by electrical leads internal to device 700 in a multitude of different ways. For example, each of the aforementioned devices may be separately connected to a master bus internal to device 700, to allow for the devices to exchange information. However, as the skilled person will appreciate, this is only one example and depending on the embodiment various ways of interconnecting at least two of the aforementioned devices may be selected.

The term “non-transitory” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

1. An apparatus comprising:
at least one processor; and
at least one memory storing instructions that, when executed by the at least one processor, cause the apparatus at least to perform:
detecting that a network node is configured to operate with a first channel bandwidth associated with a first set of requirements, wherein the first channel bandwidth is at least one of: other than 5 MHz multiplied by a non-zero positive integer; or narrower than a nominal carrier bandwidth;
detecting signalling by the network node, wherein the signalling comprises an indication that apparatuses meeting the first set of requirements on at least one condition are allowed to operate in or access a network comprising the network node; and
transmitting, to the network node, at least one signal indicating that the apparatus does not meet the first set of requirements without at least one condition.

2. The apparatus of claim 1,
wherein the at least one condition is at least one of:
lower maximum output power of the apparatus than nominally defined by the first set of requirements; or
different in-band emission level of the apparatus than nominally defined by the first set of requirements;

3. The apparatus of claim 1 or 2, wherein the apparatus meets a second set of requirements comprising at least one of:
lower maximum output power of the apparatus than nominally defined by the first set of requirements; or
different in-band emission level of the apparatus than nominally defined by the first set of requirements.

4. The apparatus of claim 2 or 3,
wherein the different in-band emission level is defined based on wider channel bandwidth than the first channel bandwidth.

5. The apparatus of any preceding claim,
wherein the first channel bandwidth is less than 5 MHz; or
wherein the first channel bandwidth is 3 MHz; or
wherein the first channel bandwidth is 3 MHz to 5 MHz.

6. The apparatus of any preceding claim,
wherein a first part of a number of resource blocks of bandwidth available for uplink is associated with the first set of requirements; and
a second part of the number of the resource blocks of bandwidth available for uplink is associated with a second set of requirements, wherein the second part of the number of the resource blocks corresponds to flexible duplex operation.

7. The apparatus of any preceding claim, caused to perform:
receiving a configuration to access the network, wherein the configuration is indicative of not requiring the apparatus to meet the first set of requirements without at least one condition;
adjusting internal configuration of the apparatus to meet the first set of requirements on the at least one condition.

8. The apparatus of claim 7,
wherein the configuration is indicative of a number of resource blocks allocated for the apparatus, and wherein
the number of resource blocks is based on available spectrum; or
the number of resource blocks is based on a nominal channel bandwidth supported by the apparatus.

9. The apparatus of any preceding claim, caused to perform:
providing filtering capability of the apparatus to the network node.

10. The apparatus of any preceding claim, caused to perform:
determining requirements associated with a wider bandwidth than the first channel bandwidth;
receiving a configuration of a bandwidth region associated with more stringent requirements than those associated with the wider bandwidth;
receiving resource allocation for uplink transmission, wherein allocated resources overlap with the bandwidth region; and
applying the more stringent requirements associated with the bandwidth region for the uplink transmission.

11. The apparatus of claim 10,
wherein the more stringent requirements comprise more stringent in-band emission and maximum power reduction assumptions than the requirements associated with the first bandwidth region.

12. The apparatus of claim 1, wherein the at least one condition is different in-band emission level of the apparatus than nominally defined by the first set of requirements.

13. The apparatus of claim 12, wherein the different in-band emission level is defined based on wider channel bandwidth than the first channel bandwidth.

14. An apparatus comprising:
at least one processor; and
at least one memory storing instructions that, when executed by the at least one processor, cause the apparatus at least to perform:
determining that user equipments meeting a first set of requirements on at least one condition are allowed to operate in or access a network comprising the apparatus configured to operate with a first channel bandwidth associated with the first set of requirements, wherein the first channel bandwidth is at least one of: other than 5 MHz multiplied by a non-zero positive integer; or narrower than a nominal carrier bandwidth;
transmitting signalling comprising an indication that user equipments meeting the first set of requirements on at least one condition are allowed to operate in or access the network;
receiving, from at least one user equipment, at least one signal indicating that the at least one user equipment does not meet the first set of requirements without at least one condition.

15. The apparatus of claim 14,
wherein the at least one condition is at least one of:
lower maximum output power of the at least one user equipment than nominally defined by the first set of requirements; or
different in-band emission level of the user equipment than nominally
defined by the first set of requirements.

16. The apparatus of claim 14 or 15, wherein the at least one user equipment meets a second set of requirements comprising at least one:
lower maximum output power of the at least one user equipment than nominally defined by the first set of requirements; or
different in-band emission level of the at least one user equipment than nominally defined by the first set of requirements.

17. The apparatus of claim 16,
wherein the different in-band emission level is defined based on wider channel bandwidth than the first channel bandwidth.

18. The apparatus of any of the claims 14 to 17, caused to perform:
transmitting, to the at least one user equipment, a configuration to access the network, wherein the configuration is indicative of not requiring to meet the first set of requirements without at least one condition.

19. The apparatus of any of the claims 14 to 18, caused to perform:
receiving filtering capability of the user equipment.

20. The apparatus of any of the claims 14 to 19, caused to perform:
transmitting, to the user equipment, a configuration of a bandwidth region associated with more stringent requirements than those associated with a wider bandwidth than the first channel bandwidth;
transmitting, to the user equipment, resource allocation for uplink transmission, wherein allocated resources overlap with the bandwidth region.
